(19) United States
(12) Patent Application Publication
(10) Pub. No.: US 2023/0312899 A1
(43) Pub. Date: Oct. 5, 2023

(54) THERMOPLASTIC RESIN COMPOSITION

(71) Applicant: IDEMITSU KOSAN CO.,LTD., Tokyo (JP)

(72) Inventors: Ken SUDO, Sodegaura-shi (JP); Hiroshi YASUDA, Ichihara-shi (JP); Yohei KOORI, Ichihara-shi (JP)

(73) Assignee: IDEMITSU KOSAN CO.,LTD., Tokyo (JP)

(21) Appl. No.: 18/022,964

(22) PCT Filed: Aug. 20, 2021
(86) PCT No.: PCT/JP2021/030509

§ 371 Date: Feb. 23, 2023

(30) Foreign Application Priority Data
Aug. 27, 2020 (JP) 2020-143720

(51) Int. Cl. C08L 25/06; C08K 3/04; C08K 7/06; C08K 5/5465; C08K 5/5415

(52) U.S. Cl. CPC C08L 25/06; C08K 3/04; C08K 7/06; C08K 5/5465; C08K 5/5415

(57) ABSTRACT

A thermoplastic resin composition comprising a thermoplastic resin (A), a polyarylene ether modified with a functional group (B), a coupling agent (C), and carbon fibers (D).

### TECHNICAL FIELD

The present invention relates to a thermoplastic resin composition and a formed body thereof.

### BACKGROUND ART

In recent years, especially in the automobile field, improvement of fuel efficiency by reducing the weight thereof has been studied. For example, there is a growing movement to replace conventional metal structural members with fiber-reinforced plastics, so fiber-reinforced plastics with superior strength have been demanded. In particular, studies have been conducted on a carbon fiber composite material using thermoplastic resin as a matrix (carbon fiber reinforced thermoplastic resin, hereinafter sometimes abbreviated as CFRTP) for practical use from the viewpoint of ease of forming and ease of recycling and the like.

Patent Document 1 discloses a resin composition in which impact strength is enhanced by adding carbon fibers and organic magnesium carboxylate to a resin component composed of a polyphenylene ether resin and an aromatic vinyl-based resin.

Patent Document 2 discloses a resin composition having excellent mechanical strength and the like by mixing carbon fibers, a silane coupling agent, and a thermoplastic elastic body with polyamide 6.

Patent Document 3 discloses a flame-retardant aromatic polycarbonate-based resin composition in which the effect of preventing the drip of combustible material is remarkably improved by adding inorganic compound particles and a specific metal salt to an aromatic polycarbonate.

Patent Document 4 discloses that a styrene-based resin composition which contains a thermoplastic resin composition containing a styrene-based resin having a syndiotactic structure, and a glass filler can achieve both excellent heat resistance, mold releasability, and low gas property.

Patent Document 5 discloses that a resin composition containing a polystyrene-based resin having a syndiotactic structure, a polyamide, a compatibilizer, a specific hindered phenol-based compound, and an inorganic filler, and containing the polystyrene-based resin having a syndiotactic structure and the specific hindered phenol-based compound at a specific proportion has excellent mechanical properties and excellent long-term heat resistance such as high tensile strength retention rate and high tensile elongation retention rate.

### RELATED ART DOCUMENTS

### Patent Documents

[Patent Document 1] JP H06-287438A

[Patent Document 2] JP 2016-141809 A

[Patent Document 3] JP 2004-10825 A

[Patent Document 4] WO 2019/107526 A1

[Patent Document 5] JP 2020-105365 A

### SUMMARY OF THE INVENTION

Additional mechanical strength is required for CFRTP to be used in a variety of applications. For example, CFRTP is required to maintain mechanical strength for a long time because automobiles, aircraft, and the like used outdoors are used for a long period of time in an environment of high temperature and high humidity.

An object of the present invention is to provide a thermoplastic resin composition having high mechanical strength and excellent heat-moisture resistance.

According to the present invention, the following thermoplastic resin composition and the like are provided.
1. A thermoplastic resin composition, comprising a thermoplastic resin (A), a polyarylene ether modified with a functional group (B), a coupling agent (C), and carbon fibers (D).
2. The thermoplastic resin composition according to 1, wherein the thermoplastic resin (A) comprises syndiotactic polystyrene.
3. The thermoplastic resin composition according to 1 or 2, wherein the coupling agent (C) comprises one or more selected from the group consisting of a silane coupling agent, an aluminate coupling agent, and a titanate coupling agent.
4. The thermoplastic resin composition according to any one of 1 to 3, wherein the coupling agent (C) comprises an isocyanate-based silane.
5. The thermoplastic resin composition according to any one of 1 to 4, further comprising a sizing agent (E).
6. The thermoplastic resin composition according to 5, wherein the sizing agent (E) has an epoxy group.
7. The thermoplastic resin composition according to any one of 1 to 6, wherein the polyarylene ether modified with a functional group (B) is a dicarboxylic acid-modified polyarylene ether.
8. The thermoplastic resin composition according to 7, wherein the dicarboxylic acid-modified polyarylene ether is a fumaric acid-modified polyarylene ether or a maleic anhydride-modified polyarylene ether.
9. A formed body composed of the thermoplastic resin composition according to any one of 1 to 8.
10. The formed body according to 9, wherein the strength retention rate after the heat-moisture treatment at 120° C. for 500 hours represented by the following formula (1) is 80% or more.

$$strength retention rate ( \% ) = \frac{tensile strength after heat - moisture treatment}{tensile strength after forming} \times 100 \qquad ( 1 )$$

11. A formed body comprising a thermoplastic resin composition, the composition comprising a thermoplastic resin (A), a polyarylene ether modified with a functional group (B), and carbon fibers (D), wherein the strength retention rate after the heat-moisture treatment at 120° C. for 500 hours represented by the following formula (1) is 80% or more.

$$strength retention rate ( \% ) = \frac{tensile strength after heat - moisture treatment}{tensile strength after forming} \times 100 \qquad ( 1 )$$

According to the present invention, it is possible to provide a thermoplastic resin composition having high mechanical strength and excellent heat-moisture resistance.

### MODE FOR CARRYING OUT THE INVENTION

### Thermoplastic Resin Composition

The thermoplastic resin composition according to one aspect of the present invention contains a thermoplastic resin (A), a polyarylene ether modified with a functional group (B), a coupling agent (C), and carbon fibers (D). By combining the components (A) to (D), the mechanical strength is increased and the heat-moisture resistance is also increased.

Hereinafter, each component of this aspect will be described.

### Thermoplastic Resin (A)

The thermoplastic resin (A) used in the production of the thermoplastic resin composition according to one aspect of the present invention is not particularly limited as long as it is a thermoplastic resin other than the polyarylene ether modified with a functional group (B) to be described later, and specific examples thereof include polyamide resins, acrylic resins, polyphenylene sulfide resins, polyvinyl chloride resins, polystyrene-based resins, polyolefins, polyacetal resins, polycarbonate-based resins, polyurethanes, polybutylene terephthalates, acrylonitrile butadiene styrene (ABS) resins, modified polyphenylene ether resins, phenoxy resins, polysulfones, polyether sulfones, polyether ketones, polyether ether ketones, aromatic polyesters, epoxy resins, and the like. Among them, at least one selected from the group consisting of a polycarbonate-based resin, a polystyrene-based resin, a polyamide, and a polyolefin is preferable, and a polyamide resin, a polyphenylene sulfide resin, a polycarbonate-based resin, or a polystyrene-based resin is more preferable. According to one aspect of the present invention, the thermoplastic resin (A) is a polyphenylene sulfide resin, a polystyrene-based resin, or a polyamide resin.

The polystyrene-based resin is not particularly limited, and examples thereof include homopolymers of a styrene-based compound, copolymers of two or more styrene-based compounds, and rubber-modified polystyrene resins (high-impact polystyrene) obtained by dispersing a rubber-like polymer in a particulate form in a matrix composed of a polymer of a styrene-based compound. Examples of the styrene-based compound as raw material include styrene, o-methylstyrene, p-methylstyrene, m-methylstyrene, α-methylstyrene, ethylstyrene, α-methyl-p-methylstyrene, 2,4-dimethylstyrene, monochlorostyrene, p-tert-butylstyrene, and the like.

The polystyrene-based resin may be a copolymer obtained by using two or more styrene-based compounds in combination, and among them, polystyrene obtained by polymerizing styrene alone is preferable. Examples thereof include polystyrene having a stereoregular structure such as atactic polystyrene, isotactic polystyrene, and syndiotactic polystyrene. Among them, syndiotactic polystyrene is preferable as the thermoplastic resin (A) contained in the resin composition of the present invention.

The syndiotactic polystyrene, which is used in the production of the thermoplastic resin composition according to one aspect of the present invention, means a styrene-based resin having a highly syndiotactic structure (hereinafter, sometimes abbreviated as SPS). In this specification, “syndiotactic” means that the proportion of the phenyl rings in adjacent styrene units arranged alternately with respect to the plane formed by the main chain of the polymer block (hereinafter referred to as syndiotacticity) is high.

The tacticity can be quantitatively identified by isotope-carbon nuclear magnetic resonance (¹³C-NMR). The ¹³C-NMR method can be used to quantify the abundance of multiple contiguous structural units, e.g., two contiguous monomer units as dyad, three monomer units as triad, and five monomer units as pentad.

The “styrene-based resin having a highly syndiotactic structure” means polystyrene, poly(hydrocarbon-substituted styrene), poly(halogenated styrene), poly(halogenated alkylstyrene), poly(alkoxystyrene), poly(vinyl benzoate), hydrogenated polymers or mixtures thereof, or copolymer composed mainly of these, which generally has a syndiotacticity of 75 mol % or more, preferably 85 mol % or more in racemic diad (r), or a syndiotacticity of 30 mol % or more, preferably 50 mol % or more in racemic pentad (rrrr).

Examples of the poly(hydrocarbon-substituted styrene) include poly(methylstyrene), poly(ethylstyrene), poly(isopropylstyrene), poly(tert-butylstyrene), poly(phenyl)styrene, poly(vinylnaphthalene), poly(vinylstyrene), and the like. Examples of the poly(halogenated styrene) include poly(chlorostyrene), poly(bromostyrene), poly(fluorostyrene), and the like, and examples of the poly(halogenated alkylstyrene) include poly(chloromethylstyrene), and the like. Examples of the poly(alkoxystyrene) include poly(methoxystyrene), poly(ethoxystyrene), and the like.

Among the above styrene-based polymers, polystyrene, poly(p-methylstyrene), poly(m-methylstyrene), poly(p-tert-butylstyrene), poly(p-chlorostyrene), poly(m-chlorostyrene), and poly(p-fluorostyrene) are particularly preferable.

Examples thereof include a copolymer of styrene and p-methylstyrene, a copolymer of styrene and p-tert-butylstyrene, and a copolymer of styrene, divinylbenzene, and the like.

The molecular weight of the syndiotactic polystyrene is not particularly limited, and the weight-average molecular weight is preferably 1×10⁴ or larger and 1×10⁶ or smaller, more preferably 50,000 or larger and 500,000 or smaller, and still more preferably 50,000 or larger and 300,000 or smaller from the viewpoint of the flowability of the resin at the time of forming and the mechanical properties of the obtained formed body. When the weight-average molecular weight is 1×10⁴ or larger, a formed body having satisfactory mechanical properties can be obtained. On the other hand, when the weight-average molecular weight is 1×10⁶ or smaller, the flowability of the resin at the time of forming is not problematic.

When the MFR of syndiotactic polystyrene is measured under the conditions of 300° C. and a load of 1.2 kgf, MFR is preferably 2 g/10 min or higher, and preferably 4 g/10 min or higher. Within the range, there is no problem with the flowability of the resin during forming. When MFR is 50 g/10 min or lower, preferably 40 g/ min or lower, and more preferably 30 g/ min or lower, a formed body having satisfactory mechanical properties can be obtained.

Syndiotactic polystyrene can be produced, for example, by polymerizing styrene monomers catalyzed by a titanium compound and a fused product of water and trialkylaluminum (aluminoxane) in an inert hydrocarbon solvent or in the absence of a solvent (see, for example, JP 2009-068022 A, WO 2019/107525 A1).

The content of the thermoplastic resin (A) is preferably 80 to 97 by mass, more preferably 85 to 95% by mass, in the resin component contained in the thermoplastic resin composition.

When the content of the thermoplastic resin (A) is within the above range, the effect of excellent heat resistance, low water absorption, and forming processability can be attained.

In the present specification, the resin component contained in the thermoplastic resin composition means a thermoplastic resin (A) and a polyarylene ether modified with a functional group (B).

### Polyarylene Ether Modified with a Functional Group (B)

The polyarylene ether modified with a functional group used in the production of the thermoplastic resin composition according to one aspect of the present invention can be obtained, for example, by reacting a polyarylene ether with a modifier.

The polyarylene ether used as raw material of the polyarylene ether modified with a functional group used in the production of the thermoplastic resin composition according to one aspect of the present invention is not particularly limited.

Examples of the polyarylene ether include poly(2,3-dimethyl-6-ethyl-1,4-phenylene ether), poly(2-methyl-6-chloromethyl-1,4-phenylene ether), poly(2-methyl-6-hydroxylethyl-1,4-phenylene ether), poly(2-methyl-6-n-butyl-1,4-phenylene ether), poly(2-ethyl-6-isopropyl-1,4-phenylene ether), poly(2-ethyl-6-n-propyl-1,4-phenylene ether), poly(2,3,6-trimethyl-1,4-phenylene ether), poly[2-(4′-methylphenyl)-1,4-phenylene ether], poly(2-phenyl-1,4-phenylene ether), poly(2-chloro-1,4-phenylene ether), poly(2-methyl-1,4-phenylene ether), poly(2-chloro-6-ethyl-1,4-phenylene ether), poly(2-chloro-6-bromo-1,4-phenylene ether), poly(2,6-di-n-propyl-1,4-phenylene ether), poly(2-methyl-6-isopropyl-1,4-phenylene ether), poly(2-chloro-6-methyl-1,4-phenylene ether), poly(2-methyl-6-ethyl-1,4-phenylene ether), poly(2,6-dibromo-1,4-phenylene ether), poly(2,6-dichloro-1,4-phenylene ether), poly(2,6-diethyl-1,4-phenylene ether), poly(2,6-dimethyl-1,4-phenylene ether), and the like. Alternatively, the polymers and copolymers described in U.S. Pat. Nos. 3,306,874, 3,306,875, 3,257,357, and 3,257,358 are also suitable. Further, examples thereof include graft copolymers and block copolymers of a vinyl aromatic compound such as polystyrene and the above-mentioned polyphenylene ether. Among these, poly(2,6-dimethyl-1,4-phenylene ether) is particularly preferably used.

The degree of polymerization of the polyarylene ether is not particularly limited, and can be appropriately selected depending on the purpose of use and the like, and can be generally selected from the range of 60 to 400. When the degree of polymerization is 60 or higher, the strength of the thermoplastic resin composition containing the polyarylene ether modified with a functional group can be improved, as will be described later. When the degree of polymerization is 400 or lower, good formability can be maintained.

Examples of the modifier for modifying the polyarylene ether include an acid modifier, an amino group-containing modifier, a phosphorus compound, a hydroxyl group-containing modifier, a halogen-containing modifier, an epoxy group-containing modifier, an unsaturated hydrocarbon group-containing modifier, and the like. Examples of the acid modifier include a dicarboxylic acid and a derivative thereof.

Examples of the dicarboxylic acid used as the modifier include maleic anhydride and a derivative thereof, fumaric acid and a derivative thereof. The derivative of maleic anhydride are compounds having an ethylenic double bond and a polar group such as a carboxyl group or an acid anhydride group in the same molecule. Specific examples thereof include maleic acid, maleate monoester, maleate diester, maleimide, and its N-substitutes (e.g., N-substituted maleimide, maleate monoamide, maleate diamide, etc.), an ammonium salt of maleate, a metallic salt of maleate, acrylic acid, methacrylic acid, methacrylic acid ester, glycidyl methacrylate and the like. Specific examples of the derivative of fumaric acid include fumaric acid diester, a metal salt of fumaric acid, an ammonium salt of fumarate, fumaric acid halide, and the like. Among these, fumaric acid or maleic anhydride is particularly preferably used.

The polyarylene ether modified with a functional group is preferably a dicarboxylic acid-modified polyarylene ether, and more preferably a fumaric acid-modified polyarylene ether or a maleic acid-modified polyarylene ether. Specific examples thereof include a modified polyphenylene ether-based polymer such as a (styrene-maleic anhydride)-polyphenylene ether-graft polymer, a maleic anhydride-modified polyphenylene ether, a fumaric acid-modified polyphenylene ether, a glycidyl methacrylate-modified polyphenylene ether, and an amine-modified polyphenylene ether. Among them, a modified polyphenylene ether is preferred, a maleic anhydride-modified polyphenylene ether or a fumaric acid-modified polyphenylene ether is more preferred, and a fumaric acid-modified polyphenylene ether is particularly preferred.

The level of modification (degree of modification or amount of modification) of the polyarylene ether modified with a functional group can be determined by infrared (IR) absorptiometry or titration.

When the degree of modification is determined from infrared (IR) absorptiometry, the degree of modification can be determined from the intensity ratio of the spectrum of the peak intensity indicating the absorption of the compound used as the modifier and the peak intensity indicating the absorption of the corresponding polyarylene ether. For example, in the case of a fumaric acid-modified polyphenylene ether, the degree of modification is determined from the peak intensity at 1790 cm⁻¹ (I_{A}) showing the absorption of fumaric acid and the peak intensity at 1704 cm⁻¹ (I_{B}) showing the absorption of polyphenylene ether (PPE) by using the following formula.

Degree of modification=(I_{A})/(I_{B})

The degree of modification of the functional group-modified polyarylene ether is preferably 0.05 to 20.

In the case of titration, the amount of modification can be determined as the acid content from the neutralized titration measured according to JIS K 0070-1992. The amount of modification of the polyarylene ether modified with a functional group is preferably from 0.1 to 20% by mass, more preferably from 0.5 to 15% by mass, still more preferably from 1.0 to 10% by mass, particularly preferably from 1.0 to 5.0% by mass, based on the mass of the polyarylene ether.

The polyarylene ether modified with a functional group can be prepared by reacting the polyarylene ether with the modifier described above in the presence or absence of a radical generator, arbitrarily in the presence of a solvent or other resin. As a modification method, solution modification and melt modification are known.

When the above-described fumaric acid or derivative thereof is used as a modifier, the fumaric acid-modified polyarylene ether can be obtained by reacting a polyarylene ether with fumaric acid or a derivative thereof in the presence or absence of a radical generator, arbitrary in the presence of an aromatic hydrocarbon solvent and other resin. The aromatic hydrocarbon solvent is not particularly limited as long as the solvent dissolves polyarylene ether, fumaric acid or a derivative thereof, and an arbitrarily used radical generator and is inert to the generated radicals. Specific examples thereof include benzene, toluene, ethylbenzene, xylene, chlorobenzene, and tert-butylbenzene. Among them, it is preferable to use benzene, toluene, chlorobenzene, and tert-butylbenzene, which have small chain transfer constants. The solvent may be used alone or in a mixture of two or more thereof. The proportion of the aromatic hydrocarbon solvent to be used is not particularly limited, and may be appropriately selected depending on the circumstances. In general, the proportion may be determined in the range of 1 to 20 times (mass ratio) with respect to the polyarylene ether used.

The usage proportion of fumaric acid or a derivative thereof used as the modifier is preferably 1 to 20 parts by mass, more preferably 3 to 15 parts by mass, based on 100 parts by mass of the polyarylene ether. When the usage proportion is 1 part by mass or larger, a sufficient amount of modification (degree of modification) is attained. When the usage proportion is 20 parts by mass or smaller, post-treatment such as purification after modification can be appropriately performed.

The radical generator arbitrarily used for solution modification of the polyarylene ether is not particularly limited. From the view point of effectively grafting the modifier to the polyarylene ether and having a decomposition temperature suitable for the reaction temperature, a radical generator having a large hydrogen abstraction ability is preferable. Specific examples thereof include di-tert-butyl peroxide, dicumyl peroxide, 1,1-bis(tert-butylperoxy)cyclohexane, 1,1-bis(tert-butylperoxy)-3,3,5-trimethylcyclohexane, benzoyl peroxide, and decanoyl peroxide. The usage proportion of the radical generator is preferably 15 parts by mass or smaller with respect to 100 parts by mass of the polyarylene ether. The usage proportion of the radical generator is preferably 15 parts by mass or smaller because insoluble components are less likely to be generated. When the above modification is carried out in the absence of a radical generator, a polyarylene ether having a low amount of modification (degree of modification) (for example, the amount of modification is 0.3 to 0.5% by mass) is obtained.

When the polyarylene ether is solution-modified, specifically, for example, a polyarylene ether and fumaric acid or a derivative thereof as a modifier are dissolved in an aromatic hydrocarbon solvent to be homogeneous, and then, when a radical generator is used, a radical generator is added at an arbitrary temperature at which the half-life of the radical generator is 1 hour or shorter, and the reaction is carried out at the temperature. Temperatures at which the half-life of the radical generator used exceeds 1 hour are not preferable because a long reaction time is required.

The reaction time can be appropriately selected, and in order to effectively act the radical generator, it is preferable to carry out a modification reaction at a predetermined reaction temperature for a time of three times or more of the half-life of the radical generator.

After completion of the reaction, the reaction solution can be added to a poor solvent of polyarylene ether such as methanol, and the precipitated modified polyarylene ether can be recovered and dried to obtain the desired polyarylene ether modified with a functional group.

When the polyarylene ether is melt-modified, the polyarylene ether and, for example, fumaric acid or a derivative thereof as the modifying agent can be melt-kneaded using an extruder in the presence or absence of a radical generator to obtain a polyarylene ether modified with a functional group. The usage proportion of fumaric acid or a derivative thereof is preferably 1 to 5 parts by mass, more preferably 2 to 4 parts by mass, based on 100 parts by mass of the polyarylene ether. When the usage proportion is 1 part by mass or larger, a sufficient amount of modification (degree of modification) is attained, and when the usage proportion is 5 parts by mass or smaller, the modification efficiency of fumaric acid or a derivative thereof is maintained satisfactorily, and the amount of fumaric acid or the like remaining in the pellets can be suppressed.

The radical generator used for melt modification of the polyarylene ether preferably has a temperature at which a half-life becomes 1-minute (1-minute half-life temperature) of 300° C. or higher. When the radical generator has 1-minute half-life temperature of less than 300° C., for example, a peroxide, an azo compound, or the like is used, the modifying effect of the polyarylene ether is insufficient.

Specific examples of the radical generator include 2,3-dimethyl-2,3-diphenylbutane, 2,3-diethyl-2,3-diphenylbutane, 2,3-diethyl-2,3-diphenylhexane, 2,3-dimethyl-2,3-di(p-methylphenyl)butane, and the like. Among them, 2,3-dimethyl-2,3-diphenylbutane having 1 minute half-life temperature of 330° C. is preferably used.

The usage proportion of the radical generator is preferably 0.1 to 3 parts by mass, and more preferably 0.5 to 2 parts by mass, based on 100 parts by mass of the polyarylene ether. When the usage proportion is 0.1 parts by mass or larger, a high modification effect is attained, and when the usage proportion is 3 parts by mass or smaller, the polyarylene ether can be efficiently modified, and insoluble components are less likely to be generated.

Examples of the method for melt-modifying the polyarylene ether include a method in which a polyarylene ether, fumaric acid or a derivative thereof, and a radical generator are uniformly dry-blended at room temperature, and then a melt reaction is performed in a range of 300 to 350° C., which is substantially a kneading temperature of the polyarylene ether. When the temperature is 300° C. or higher, the melt viscosity can be appropriately maintained, and when the temperature is 350° C. or lower, the decomposition of the polyarylene ether can be suppressed.

Among the polyarylene ether modified with a functional group obtained by the method described in detail above, in the case of particularly preferred fumaric acid-modified polyarylene ether, the modification amount (modifier content) determined by the titration method described above is preferably 0.1 to 20% by mass, more preferably 0.5 to 15% by mass, still more preferably 1 to 10% by mass, and particularly preferably 1.0 to 5.0% by mass. When the amount of modification is 0.1% by mass or larger, a polyarylene ether having sufficient physical properties and heat resistance can be obtained. The amount of modification is sufficient to be 20% by mass or smaller.

From the viewpoint of increasing the interfacial shear strength between the resin component and the carbon fibers (D), the content of the polyarylene ether modified with a functional group (B) is preferably 3 to 20% by mass, more preferably 5 to 15% by mass, in the resin component contained in the thermoplastic resin composition.

When the content of the polyarylene ether modified with a functional group (B) is 3% by mass or larger, excellent interfacial shear strength can be attained. When the content of the polyarylene ether (B) is 20% by mass or smaller, the mechanical strength and heat resistance of the obtained formed body can be maintained satisfactorily.

### Coupling Agent (C)

Examples of the coupling agent used in the production of the thermoplastic resin composition according to one aspect of the present invention include a silane coupling agent, an aluminate coupling agent, a titanate coupling agent, and the like. The coupling agent may be used alone, or in a combination of two or more.

The coupling agent used in the production of the thermoplastic resin composition according to one aspect of the present invention preferably contains at least one selected from the group consisting of a silane coupling agent, an aluminate coupling agent, and a titanate coupling agent.

Examples of the silane coupling agent include vinyltrimethoxysilane, vinyltriethoxysilane, 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, N-(vinylbenzyl)-2-aminoethyl-3-aminopropyltrimethoxysilane hydrochloride, tris-(trimethoxysilylpropyl)isocyanurate, 3-ureidopropyltrialkoxysilane, 3-mercaptopropyltrimethoxysilane, 3-mercaptopropylmethyldimethoxysilane, 3-isocyanatopropyltriethoxysilane, 3-trimethoxysilylpropylsuccinic anhydride, and the like.

Examples of the aluminate coupling agent include an alkylacetate aluminum diisopropylate and the like.

Examples of the titanate coupling agent include isopropyl triisostearoyl titanate, tetraoctyl bis(ditridecyl phosphite)titanate, bis(dioctyl pyrophosphate)oxyacetate titanate, isoprobyl tridodecyl benzene sulfonyl titanate, and the like.

The coupling agent used in the production of the thermoplastic resin composition according to one aspect of the present invention preferably contains at least one selected from the group consisting of a silane coupling agent, an aluminate coupling agent, and a titanate coupling agent, and more preferably contains an isocyanate-based silane (for example, tris-(trimethoxysilylpropyl)isocyanurate or 3-isocyanatopropyltriethoxysilane). Thus, the effect of increasing the heat-moisture resistance can be attained.

The content of the coupling agent (C) is preferably 0.3 to 3.0 parts by mass, more preferably 0.5 to 1.5 parts by mass, based on 100 parts by mass of the total of the resin components contained in the thermoplastic resin composition.

The coupling agent may be present in a form different from that at the time of blending, due to the reaction of the functional group.

### Carbon Fibers (D)

The carbon fibers contained in the thermoplastic resin composition according to one aspect of the present invention are not particularly limited, and various carbon fibers such as PAN-based fibers made from polyacrylonitrile, pitch-based fibers made from coal tar pitch in petroleum or coal, and phenol-based fibers made from a thermosetting resin, for example, a phenolic resin can be used. The carbon fibers may be obtained by a vapor deposition method or may be recycled carbon fibers (RCF). As described above, the carbon fibers are not particularly limited, and are preferably at least one of carbon fibers selected from the group consisting of PAN-based carbon fibers, pitch-based carbon fibers, thermosetting carbon fibers, phenol-based carbon fibers, vapor-grown carbon fibers, and recycled carbon fibers (RCF).

The carbon fibers have a graphitization degree changed by the raw material quality and firing temperature at the time of production, and the carbon fibers can be used regardless of the graphitization degree. The shape of the carbon fibers is not particularly limited, and it is possible to use carbon fibers having at least one shape selected from the group consisting of milled fiber, sized cutting (chopped strand), short fiber, roving, filament, tow, whisker, nanotube, and the like. In the case of sized cutting (chopped strand), the average fiber length is preferably 0.1 to 50 mm and the average fiber diameter is 5 to 20 μm.

The density of the carbon fibers is not particularly limited, and is preferably 1.75 to 1.95 g/cm³.

The carbon fiber may be in the form of single fibers or fiber bundles, or a mixture of both single fibers and fiber bundles. The number of single fibers in each fiber bundle may be substantially uniform or different in each fiber bundle. The average fiber diameter of the carbon fibers varies depending on the form, but for example, the carbon fibers having an average fiber diameter of preferably 0.0004 to 15 μm, more preferably 3 to 15 μm, and still more preferably 5 to 10 μm can be used.

The content of the carbon fibers (D) is preferably 10 to 300 parts by mass, and more preferably 20 to 200 parts by mass, based on 100 parts by mass of the total of the resin components contained in the thermoplastic resin composition. When the amount of the carbon fibers (D) is within the above range, the formed body or the composite material containing the thermoplastic resin composition of the present aspect has excellent mechanical strength.

As described above, in the present specification, the thermoplastic resin composition according to one aspect of the present invention may contain a thermoplastic resin (A), a polyarylene ether modified with a functional group (B), a coupling agent (C), and carbon fibers (D) by any method. An immersed material (composite material) in which a member containing carbon fibers (D) is immersed in a mixture containing a thermoplastic resin (A), a polyarylene ether modified with a functional group (B), and a coupling agent (C) is also included in the “composition” and “formed body containing the composition” in the present invention. Examples thereof include an immersed material in which a carbon fibers member in the form of a woven fabric, nonwoven fabric, or unidirectional material is immersed in a mixture containing a thermoplastic resin (A), a polyarylene ether modified with a functional group (B), and a coupling agent (C).

Further, after carbon fibers (D) are previously added to a polyarylene ether modified with a functional group (B), a thermoplastic resin (A) and a coupling agent (C) may be added to obtain a thermoplastic resin composition.

In the case where the member containing carbon fibers is a woven fabric, a nonwoven fabric, or a unidirectional material, single fibers having an average fiber diameter of preferably 3 to 15 μm, more preferably 5 to 7 μm may be used. In addition, in a case where the member containing carbon fibers has a form of a woven fabric, a nonwoven fabric, or a unidirectional material, a bundle (fiber bundle) in which carbon fibers are bundled in one direction may be used. As the member containing carbon fibers, a bundle of 6000 (6K), 12000 (12K), 24000 (24K), 60000 (60K) or the like carbon fiber monofilaments supplied from a carbon fiber manufacturer as the fiber bundle may be used as is, or a bundle thereof may be used. The fiber bundle may be any of a non-twisted yarn, a twisted yarn, and an untwisted yarn. The fiber bundle may be contained in a state of being opened in a formed body, or may be contained as a fiber bundle without being opened. When the member containing carbon fibers is a woven fabric, a nonwoven fabric, or a unidirectional material, the member can be immersed in a mixture containing a thermoplastic resin (A), a polyarylene ether modified with a functional group (B), and a coupling agent (C) to obtain a formed body.

The member containing carbon fibers, in particular, a woven fabric, a nonwoven fabric, and a unidirectional material is preferably thin in thickness. From the viewpoint of obtaining a thin carbon fiber composite material, the thickness of the member containing carbon fibers is preferably 3 mm or smaller. In particular, the unidirectional material preferably has a thickness of 0.2 mm or smaller. The lower limit of the thickness of the member containing carbon fibers is not particularly limited, and the thickness is preferably 7 μm or larger, and is preferably 10 μm or larger, more preferably 20 μm or larger from the viewpoint of stability of quality.

### Sizing Agent (E)

The thermoplastic resin composition according to one aspect of the present invention may further contain a sizing agent. The sizing agent is not particularly limited as long as the material sizes carbon fibers. In addition, the carbon fibers contained in the thermoplastic resin composition of the present aspect may have a surface to which a sizing agent are attached. When carbon fibers to which the sizing agent is attached is used, the type of the sizing agent may be appropriately selected depending on the type of the carbon fibers and the thermoplastic resin, and is not particularly limited. Carbon fibers have been commercialized in a variety of products, such as epoxy-based sizing agent, urethane-based sizing agent, those treated with a polyamide-based sizing agent, or those containing no sizing agent, etc., and in the present aspect, carbon fibers may be used regardless of the type and presence or absence of the sizing agent. In particular, from the viewpoint of the tensile strength of the formed body after the heat-moisture treatment, carbon fibers are preferable to contain a sizing agent having an epoxy group.

The sizing agent may coat some or all of the surface of carbon fibers. The sizing agent does not necessarily have to be entirely attached to carbon fibers in the thermoplastic resin composition, and may be separated from carbon fibers and dispersed in the thermoplastic resin composition.

Examples of the commercially available product of carbon fibers (D) to which a sizing agent having an epoxy group is attached include Tenax (registered trademark) chopped fiber HTC261 manufactured by TEIJIN LIMITED, and Pyrofil (registered trademark) chopped fiber TR066A manufactured by Mitsubishi Chemical Corporation (hereafter, treated with an epoxy-based sizing agent). Alternatively, a Pyrofil (registered trademark) chopped fiber TR06Q (treated with a special epoxy-based sizing agent) manufactured by Mitsubishi Chemical Corporation may be used.

The content of the sizing agent is preferably 0.3 to 5.0% by mass, more preferably 1.0 to 3.0% by mass, based on the total of the carbon fibers (D) and the sizing agent.

In the calculation of the blending amount of the thermoplastic resin composition, the mass of the sizing agent is contained in the mass of the carbon fibers. That is, the total of the sizing agent and the carbon fibers is calculated as the mass of the carbon fibers (D).

### Other Components

To the thermoplastic resin composition according to one aspect of the present invention, other components such as a rubber-like elastic body, an antioxidant, carbon fibers described above or a filler other than carbon fibers, a crosslinking agent, a crosslinking aid, a nucleating agent, a mold release agent, a plasticizer, a compatibilizer, a colorant, and/or an antistatic agent which are generally used may be added, as long as the object of the present invention is not inhibited. Some of the other components are exemplified below.

As a rubber-like elastic body, various materials can be used. Examples thereof include, for example, natural rubber, polybutadiene, polyisoprene, polyisobutylene, chloroprene rubber, polysulfide rubber, thiocol rubber, acrylic rubber, urethane rubber, silicone rubber, epichlorohydrin rubber, styrene-butadiene block copolymer (SBR), hydrogenated styrene-butadiene block copolymer (SEB), styrene-butadiene-styrene block copolymer (SBS), hydrogenated styrene-butadiene-styrene block copolymer (SEBS), styrene-isoprene block copolymer (SIR), hydrogenated styrene-isoprene block copolymer (SEP), styrene-isoprene-styrene block copolymer (SIS), hydrogenated styrene-isoprene-styrene block copolymer (SEPS), a styrene-butadiene random copolymer, a hydrogenated styrene-butadiene random copolymer, a styrene-ethylene-propylene random copolymer, styrene-ethylene-butylene random copolymer, ethylene propylene rubber (EPR), ethylene propylene diene rubber (EPDM); core-shell type particle elastic materials such as acrylonitrile-butadiene-styrene-core-shell rubber (ABS), methyl methacrylate-butadiene-styrene-core-shell rubber (MBS), methyl methacrylate-butyl acrylate-styrene-core-shell rubber (MAS), octyl acrylate-butadiene-styrene-core-shell rubber (MABS), alkyl acrylate-butadiene-acrylonitrile-styrene core-shell rubber (AABS), butadiene-styrene-core-shell rubber (SBR), methyl methacrylate-butyl acrylate siloxane and other siloxane-containing core-shell rubbers; or rubbers modifying these materials.

Among these, particularly, SBR, SBS, SEB, SEBS, SIR, SEP, SIS, SEPS, core-shell rubber, rubber modifying these materials, and the like are preferably used.

Examples of the modified rubber-like elastic body include, for example, rubber which modified styrene-butylacrylate copolymer rubber, styrene-butadiene block copolymer (SBR), hydrogenated styrene-butadiene block copolymer (SEB), styrene-butadiene-styrene block copolymer (SBS), hydrogenated styrene-butadiene-styrene block copolymer (SEBS), styrene-isoprene block copolymer (SIR), hydrogenated styrene-isoprene block copolymer (SEP), styrene-isoprene-styrene block copolymer (SIS), hydrogenated styrene-isoprene-styrene block copolymer (SEPS), styrene-butadiene random copolymer, hydrogenated styrene-butadiene random copolymer, styrene-ethylene-propylene random copolymer, styrene-ethylene-butylene random copolymer, ethylene propylene rubber (EPR), ethylene propylene diene rubber (EPDM), and the like with a modifier having a polar group.

As a filler, carbon fibers may be added, and in addition to carbon fibers, an organic filler may also be added. Examples of the organic filler include organic synthetic fibers and natural plant fibers. Specific examples of the organic synthetic fibers include wholly aromatic polyamide fibers, polyimide fibers, polyparaphenylene benzoxazole fibers, and the like. The organic filler may be used alone or in a combination of two or more thereof, and the addition amount of the organic fillers is preferably from 1 to 350 parts by mass, more preferably from 5 to 200 parts by mass, based on 100 parts by mass of the total of the resin components contained in the thermoplastic resin composition. When the addition amount is 1 part by mass or larger, the effect of the filler is sufficiently attained, and when the addition amount is 350 parts by mass or smaller, the dispersibility is not inferior and the formability is not adversely affected.

A variety of antioxidants are available, and in particular, a phosphorus-based antioxidant such as monophosphite and diphosphite, for example, tris(2,4-di-tert-butylphenyl)phosphite, tris(mono- and di-nonylphenyl)phosphite, and a phenol-based antioxidant are preferable.

The diphosphite is preferably a phosphorus-based compound represented by the following formula.

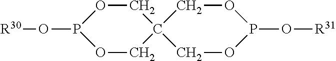

In the formula, R³⁰ and R³¹ independently represent an alkyl group including 1 to 20 carbon atoms, a cycloalkyl group including 3 to 20 carbon atoms, or an aryl group including 6 to 20 carbon atoms.

Specific examples of the phosphorus-based compound represented by the above formula include distearylpentaerythritol diphosphite, dioctylpentaerythritol diphosphite, diphenylpentaerythritol diphosphite, bis(2,4-di-tert-butylphenyl)pentaerythritol diphosphite, bis(2,6-di-tert-butyl-4-methylphenyl)pentaerythritol diphosphite, dicyclohexylpentaerythritol diphosphite, and the like.

As a phenolic antioxidant, known materials may be used, and specific examples thereof include 2,6-di-tert-butyl-4-methylphenol, 2,6-diphenyl-4-methoxyphenol, 2,2′-methylenebis(6-tert-butyl-4-methylphenol), 2,2′-methylenebis[4-methyl-6-(α-methylcyclohexyl)phenol], 1,1-bis(5-tert-butyl-4-hydroxy-2-methylphenyl)butane, 2,2′-methylenebis(4-methyl-6-cyclohexylphenol), 2,2′-methylenebis(4-methyl-6-nonylphenol), 1,1,3-tris(5-tert-butyl-4-hydroxy-2-methylphenyl)butane, 2,2-bis(5-tert-butyl-4-hydroxy-2-methylphenyl)-4-n-dodecylmercaptobutane, ethylene glycol-bis[3,3-bis(3-tert-butyl-4-hydroxyphenyl)butyrate], 1,1-bis(3,5-dimethyl-2-hydroxyphenyl)-3-(n-dodecylthio)-butane, 4,4′-thiobis(6-tert-butyl-3-methylphenol), 1,3,5-tris(3,5-di-tert-butyl-4-hydroxybenzyl)-2,4,6-trimethylbenzene, 2,2-bis(3,5-di-tert-butyl-4-hydroxybenzyl)malonate dioctadecyl ester, n-octadecyl-3-(4-hydroxy-3,5-di-tert-butylphenyl)propionate, tetrakis[methylene(3,5-di-tert-butyl-4-hydroxyhydrocinnamate)]methane, and the like.

In addition to the phosphorus-based antioxidant and the phenol-based antioxidant described above, an amine-based antioxidant, a sulfur-based antioxidant, or the like may be used alone or in combination.

The blending amount of the antioxidant described above is generally 0.005 parts by mass or larger and 5 parts by mass or smaller based on 100 parts by mass of the total of the resin components contained in the thermoplastic resin composition. When the blending ratio of the antioxidant is 0.005 parts by mass or larger, a decrease in the molecular weight of the thermoplastic resin (A) can be suppressed. When the blending ratio is 5 parts by mass or smaller, the mechanical strength can be maintained satisfactorily. When a plurality of antioxidants is contained in the composition as the antioxidant, it is preferable to adjust the total amount to be in the above range. The blending amount of the antioxidant is more preferably 0.01 to 4 parts by mass, and still more preferably 0.02 to 3 parts by mass based on 100 parts by mass of the total of the resin components contained in the thermoplastic resin composition.

The nucleating agent may be arbitrarily selected from known materials such as a metal salt of a carboxylic acid such as aluminum di(p-tert-butylbenzoate), a metal salt of phosphoric acid such as sodium methylenebis(2,4-di-tert-butylphenol)acid phosphate, talc, phthalocyanine derivatives. Specific trade names include Adekastab NA-10, Adekastab NA-11, Adekastab NA-21, Adekastab NA-30, Adekastab NA-35, Adekastab NA-70 manufactured by ADEKA CORPORATION, PTBBA-AL manufactured by DIC Corporation and the like. These nucleating agents may be used alone or in a combination of two or more. The blending amount of the nucleating agent is not particularly limited, and is preferably 0.01 to 5 parts by mass, and more preferably 0.04 to 2 parts by mass based on 100 parts by mass of the total of the resin components contained in the thermoplastic resin composition.

The mold release agent may be arbitrarily selected from known materials such as polyethylene wax, silicone oil, long-chain carboxylic acid, and long-chain carboxylic acid metal salt. These mold release agents may be used alone or in a combination of two or more. The blending amount of the mold release agent is not particularly limited, and is preferably 0.1 to 3 parts by mass, more preferably 0.2 to 1 part by mass based on 100 parts by mass of the total of the resin components contained in the thermoplastic resin composition.

The thermoplastic resin composition according to one aspect of the present invention may substantially consist of the thermoplastic resin (A), the polyarylene ether modified with a functional group (B), the coupling agent (C), and the carbon fibers (D) described above, and may also substantially consist of the (A) to (D) and the sizing agent (E) described above. The expression “substantially consist of (A) to (D) or (A) to (E)” means, for example, that the proportion of (A) to (D) or (A) to (E) in the entire thermoplastic resin composition is 80% by mass or larger, 90% by mass or larger, or 95% by mass or larger.

### Preparation of Thermoplastic Resin Composition

The method for preparing the thermoplastic resin composition according to one aspect of the present invention is not particularly limited, and may be mixed by a known mixer or melt-kneaded by an extruder or the like. The member containing carbon fibers may be immersed in molten resin. Alternatively, carbon fibers may be previously treated with a predetermined amount of a coupling agent, and kneaded or immersed.

For example, the composition may be obtained by forming a composition in which a thermoplastic resin (A), a polyarylene ether modified with a functional group (B), a coupling agent (C), carbon fibers (D), and, if necessary, various components described above are added, and injection molding. In the injection molding, a mold having a predetermined shape may be used, and in the extrusion molding, the film and the sheet may be T-die-molded, and the obtained film and the sheet may be heated and melted to be extruded into a predetermined shape.

It is preferable to use a method of side-feeding carbon fibers using a twin-screw kneader, or a method of producing a so-called long-fiber pellet in which carbon fiber roving is immersed in molten resin and cut to desired pellet length after pull-out molding, because breakage of carbon fibers can be suppressed. The thermoplastic resin composition may also be press-molded, and known methods such as a cold press method and a hot press method may be used.

When a member containing carbon fibers (D) is immersed in a mixture containing a thermoplastic resin (A), a polyarylene ether modified with a functional group (B), and a coupling agent (C) to obtain a composite member, specifically, the member containing carbon fibers (D) (woven fabric, nonwoven fabric, UD material, etc.) is immersed in a mixture containing the thermoplastic resin (A), the polyarylene ether modified with a functional group (B), and the coupling agent (C). The member to be immersed in the resin may be one sheet or a laminated body of two or more sheets.

### Method for Producing Formed Body

As described above, a formed body composed of the thermoplastic resin composition according to one aspect of the present invention may be obtained by forming the composition by mixing, melt-kneading, or immersing a thermoplastic resin (A), a polyarylene ether modified with a functional group (B), a coupling agent (C), and carbon fibers (D). As another method, a formed body may be formed by a method containing a step of producing a carbon member containing a polyarylene ether modified with a functional group (B) and carbon fibers (D), and a step of adding a thermoplastic resin (A) and a coupling agent (C) to the carbon member.

A means for producing a carbon member containing a thermoplastic resin (A), a polyarylene ether modified with a functional group (B), and carbon fibers (D) is not particularly limited. For example, a method of immersing carbon fibers (D) in a polyarylene ether modified with a functional group (B) under a suitable solvent, a method of applying a mixture of a polyarylene ether (B) to a suitable vehicle to carbon fibers (D), a method of mixing a polyarylene ether modified with a functional group (B) to a sizing agent and adding the polyarylene ether (B) to carbon fibers (D), and the like can be exemplified. When this method is used, the form of carbon fibers (D) may include at least one form selected from a chopped strand, a woven fabric, a nonwoven fabric, or a unidirectional material.

In a subsequent step, a thermoplastic resin (A) and a coupling agent (C) are added to the carbon member obtained by the above step. The method of adding a thermoplastic resin (A) and a coupling agent (C) to the carbon member is not limited, and the thermoplastic resin (A) may be in a solution state or a molten state. Specifically, a method in which a carbon member is immersed in a mixture containing a thermoplastic resin (A) and a coupling agent (C) under a suitable solvent, a method in which a film containing a thermoplastic resin (A) and a coupling agent (C) is laminated and melt-pressed, a method in which a thermoplastic resin (A) and a powder of a coupling agent (C) are directly added to a carbon member and then melted, and the like can be exemplified.

The carbon member may contain a polyarylene ether modified with a functional group (B) and carbon fibers (D), the carbon member may be in the form of a woven fabric, nonwoven fabric, or unidirectional material, and may be added with a thermoplastic resin (A) and a coupling agent (C); and after the carbon member having the form of a woven fabric or the like has a short cut chopped form, a thermoplastic resin (A) and a coupling agent (C) may be added. After a thermoplastic resin (A) and a coupling agent (C) are added to the carbon member, a formed body can be produced by various forming methods described later.

### Formed Body

The shape of the formed body according to one aspect of the present invention is not particularly limited, and examples thereof include a sheet, a film, a fiber, a woven fabric, a nonwoven fabric, a unidirectional material (UD material), a container, an injection-molded body, a blow formed body, and the like. The formed body composed of the thermoplastic resin composition according to one aspect of the present invention may be an injection-molded body as described above. Depending on the form of carbon fibers used, the formed body may also be a formed body containing a unidirectional fiber-reinforcing material, or at least one member selected from woven carbon fibers and non-woven carbon fibers. A plurality of the formed bodies may be laminated to form a laminated body. This laminated body is also included in the “formed body” in the present specification.

A formed body according to one aspect of the present invention has a high strength retention rate in a high temperature and high humidity environment. For example, the strength retention rate of the formed body of the present aspect is preferably 80% or more, and more preferably 90% or more. The strength retention rate is obtained from the tensile strength after molding and the tensile strength after 120° C. and 500 hours of heat-moisture treatment using the following formula (1). The heat-moisture treatment can be carried out by the method described in Examples.

$$strength retention rate ( \% ) = \frac{tensile strength after heat - moisture treatment}{tensile strength after forming} \times 100 \qquad ( 1 )$$

In the formed body of the present aspect obtained by forming a thermoplastic resin composition, the coupling agent (C) may not be detectable. In addition, the coupling agent (C) may be present in a form different from that at the time of blending, due to the reaction of the functional group.

Therefore, the formed body according to one aspect of the present invention may be a formed body composed of a thermoplastic resin composition containing a thermoplastic resin (A), a polyarylene ether modified with a functional group (B), and carbon fibers (D), wherein the formed body has a strength retention rate of 80% or more after a heat-moisture treatment at 120° C. for 500 hours represented by the formula (1). In the present aspect, atoms presumed to be derived from the coupling agent (C), e.g., Si, Al, and Ti, may be detected by known methods such as ICP atomic emission spectroscopy (ICP-AES).

The formed body composed of the thermoplastic resin composition according to one aspect of the present invention is suitable as an industrial material such as an electric/electronic material (connector, printed circuit board, etc.), an industrial structural material, an automotive component (a connector for installation in a vehicle, a wheel cap, a cylinder head cover, etc.), a household electric apparatus, various mechanical components, a pipe, a sheet, a tray, and a film.

The formed body according to one aspect of the present invention can be developed, specifically as a carbon-fiber-reinforced thermoplastic plastic (CFRTP), in a wide range of applications, such as automobile/aircraft/sporting goods, for which further weight reduction is required. The formed body for this application can also be applied to the improvement of engineering plastic, which is required to withstand high load environment such as high load and high temperature. The formed body composed of the thermoplastic resin composition according to one aspect of the present invention has a short forming time and excellent recyclability, is easy to immerse the resin at the time of forming, and has sufficient mechanical strength, and thus can be practically used in a wide range of applications.

Specific examples of the application include automobile applications, motorcycle/bicycle applications, water heaters and Eco Cute-related applications, home appliance applications/electronic apparatus applications, building materials applications, and daily use applications.

Examples of automotive applications include a sliding component such as a gear, an automotive panel member, a millimeter wave radome, an IGBT housing, a radiator grille, a meter hood, a fender support, a front engine cover, a front strut tower panel, a mission center tunnel, a radial core support, a front dash, a door inner, a rear luggage back panel, a rear luggage side panel, a rear luggage floor, a rear luggage partition, a roof, a door frame pillar, a seatback, a headrest support, an engine component, a crash box, a front floor tunnel, a front floor panel, an under cover, an under support rod, an impact beam, a front cowl, a front strut tower bar, and other automotive components.

The formed body composed of the thermoplastic resin composition according to one aspect of the present invention may suitably constitute, for example, a power electronic unit, a plug for rapid charging, an on-vehicle charger, a lithium ion battery, a battery control unit, a power electronic control unit, a three-phase synchronous motor, a plug for household charging, and the like.

Furthermore, the formed body composed of the thermoplastic resin composition according to one aspect of the present invention may suitably constitute, for example, a solar twilight sensor, an alternator, an EDU (electronic injector driver unit), an electronic throttle, a tumble control valve, a throttle opening sensor, a radiator fan controller, a stick coil, an A/C pipe joint, a diesel particulate collecting filter, a headlight reflector, a charge air duct, a charge air cooling head, an intake air temperature sensor, a gasoline fuel pressure sensor, a cam/crank position sensor, a combination valve, an engine oil pressure sensor, a transmission gear angle sensor, a continuously variable transmission oil pressure sensor, an ELCM (evaporative leak check module) pump, a water pump impeller, a steering roll connector, an ECU (engine computer unit) connector, an ABS (anti-lock braking system) reservoir piston, an actuator cover, and the like

The formed body composed of the thermoplastic resin composition according to one aspect of the present invention is also suitably used, for example, as a sealing material for sealing a sensor equipped in an in-vehicle sensor module. The sensor is not particularly limited, and specific examples of the sensor include an atmospheric pressure sensor (e.g., for high ground correction), a boost pressure sensor (e.g., for fuel injection control), an (Integrated-Circuited) atmospheric pressure sensor, an acceleration sensor (e.g., for an airbag), a gauge pressure sensor (e.g., for sheet condition control), an in-tank pressure sensor (e.g., for fuel tank leak detection), a refrigerant pressure sensor (e.g., for air conditioner control), a coil driver (e.g., for ignition coil control), an EGR (exhaust gas recirculation) valve sensor, an air flow sensor (e.g., for fuel injection control), a manifold absolute pressure (MAP) sensor (e.g., for fuel injection control), an oil pan, a radiator cap, an intake manifold, and the like.

The formed body composed of the thermoplastic resin composition according to one aspect of the present invention is not limited to the automobile component exemplified above, and is suitably used for, for example, a high-voltage (harness) connector, a millimeter-wave radome, an IGBT (insulated gate bipolar transistor) housing, a battery fuse terminal, a radiator grille, a meter hood, a water pump for inverter cooling, a battery monitoring unit, a structural component, an intake manifold, a high-voltage connector, a motor control ECU (engine computer unit), an inverter, a piping component, a canister purge valve, a power unit, a bus bar, a motor speed reducer, a canister, and the like.

The formed body composed of the thermoplastic resin composition according to one aspect of the present invention is also preferably used for a motorcycle component and a bicycle component, and more specifically, examples thereof include a member for a motorcycle, a cowl for a motorcycle, and a member for a bicycle. Examples of the motorcycle/bicycle application include a motorcycle member, a motorcycle cowl, and a bicycle member.

The formed body composed of the thermoplastic resin composition according to one aspect of the present invention is excellent in chemical resistance, and therefore may be used in various electric appliances. For example, a water heater, specifically, it is also preferable to constitute components of a natural refrigerant heat pump water heater known as an “Eco Cute (registered trademark)” or the like. Such components include, for example, a shower component, a pump component, a piping component, and the like, and more specifically, a one-port circulating connection fitting, a relief valve, a mixing valve unit, a heat resistance trap, a pump casing, a complex water valve, a water-inlet fitting, a resin fitting, a piping component, a resin pressure reducing valve, an elbow for a water tap, and the like.

The thermoplastic resin composition according to one aspect of the present invention is suitably used for components such as a home appliance and an electronic equipment, specifically, a phone, a mobile phone, a microwave oven, a refrigerator, a vacuum cleaner, an OA appliance, a power tool component, an electric tool component, an antistatic application, a high-frequency electronic component, a high-heat dissipation electronic component, a high-voltage component, an electromagnetic wave shielding component, a communication appliance, an AV appliance, a personal computer, a register, a fan, a ventilation fan, a sewing machine, an ink peripheral component, a ribbon cassette, an air cleaner component, a hot water flushing toilet seat component, a toilet seat, a toilet lid, a rice cooker component, an optical pick-up appliance, a luminaire component, a DVD, a DVD-RAM, a DVD pick-up component, a DVD pick-up board, a switch component, a socket, a display, a video camera, a filament, a plug, a high-speed color copiers (laser printer), an inverter, an air conditioner, a keyboard, a converter, a television, a facsimile, an optical connector, a semiconductor chip, an LED component, a laundering machine/laundering-drying machine component, a dishwasher/dishdryer component, and the like.

The formed body composed of the thermoplastic resin composition according to one aspect of the present invention is also suitably used for a building material, and more specifically, examples thereof include constituent members such as an outer wall panel, a back panel, a partition wall panel, a signal lamp, an emergency lamp, a wall material, and the like.

The formed body composed of the thermoplastic resin composition according to one aspect of the present invention is also suitably used for a general good, a daily necessity, etc., and more specifically, examples thereof include components such as a chopstick, a lunch box, a food container, a food tray, a food packaging material, a water tank, a tank, a toy, a sports article, a surfboard, a door cap, a door step, a Pachinko machine component, a remote control car, a remote controller case, stationery, a musical instrument, a tumbler, a dumbbell, a helmet box product, a shutter blade member used for cameras, etc., a racket member for table tennis or tennis, etc., and a plate member for a ski or snowboard, etc.

Each of the various components described above may be partially or entirely constituted by the formed body composed of the thermoplastic resin composition according to one aspect of the present invention.

### EXAMPLES

The present invention will be described in more detail with reference to Examples, but the present invention is not limited thereto.

Each of the components used in Examples and Comparative Examples is as follows.

### Thermoplastic Resin (A)

Thermoplastic resin 1: SPS (syndiotactic polystyrene resin, racemic pentad: 98 mol %, MFR: 13 g/10 min, melting point: 270° C.)

Except that the temperature was raised to 80° C., polymerization was carried out in the same manner as in Production Example 1 of JP 2009-068022 A.

Thermoplastic resin 2: PPS (polyphenylene sulfide resin, T-1G, manufactured by DIC Corporation)

### Polyarylene Ether Modified with a Functional Group (B)

Fumaric acid-modified PPE (produced by melt modification, amount of modification: 1.7% by weight, glass-transition point: 220° C.)

100 parts by mass of polyarylene ether [LXR040; poly(2,6-dimethyl-1,4-phenylether), manufactured by BLUESTAR NEW CHEMICAL MATERIALS Co. LTD.], 4 parts by mass of a radical generator (NOFMER BC90; 2,3-dimethyl-2,3-diphenylbutane, manufactured by NOF CORPORATION), and 2 parts by mass of a modifier (fumaric acid) were dry-blended and melt-kneaded using a twin-screw kneader (ZSK32MC manufactured by Coperion GmbH) having a cylinder diameter of 32 mm at screw rotational speed of 200 rpm and set temperature of 300° C. The strand was pelletized after cooling to obtain fumaric acid-modified polyarylene ether.

The amount of modification was determined as the acid content from the neutralized titration measured according to JIS K 0070-1992.

### Coupling Agent (C)

Silane coupling agent (isocyanate-based silane, KBE-9007N, manufactured by Shin-Etsu Chemical Co., Ltd.)

### Carbon Fibers (D), Sizing Agent (E)

Carbon fibers 1 (TR066A, chopped carbon fibers, manufactured by Mitsubishi Chemical Corporation, amount of sizing agent (epoxy-based): 3.0% by mass)

Carbon fibers 2 (TR06U, chopped carbon fibers, manufactured by Mitsubishi Chemical Corporation, amount of sizing agent (urethane-based): 2.5% by mass)

### Other Components

Rubber-like elastic body (SEPTON8006, manufactured by KURARAY CO., LTD)

Antioxidant 1 (Irganox1076, manufactured by BASF Japan Ltd.)

Antioxidant 2 (PEP36, manufactured by ADEKA CORPORATION)

Crystalline nucleating agent (NA-70, manufactured by ADEKA CORPORATION)

### Example 1

### Production of Formed Body

To a total of 100 parts by mass of resin components (SPS: 95% by mass, fumaric acid-modified PPE: 5% by mass) contained in a thermoplastic resin composition, 28 parts by mass of carbon fibers 1, 1 part by mass of a silane coupling agent, 0.2 parts by mass of an antioxidant 1, 0.2 parts by mass of antioxidant 2, and 0.3 parts by mass of crystallization nucleating agent were kneaded by using a twin-screw kneader (ZSK32MC, manufactured by Coperion GmbH) having a cylinder diameter of 32 mm. The carbon fibers were side-feeded. The obtained pellet was injection-molded using an injection-molding machine (MD100, manufactured by NIIGATA MACHINE TECHNO CO., LTD.) at a cylinder temperature of 300° C. and a mold temperature of 150° C. to obtain a test piece. An ISO mold was used as the mold.

### Evaluation of Mechanical Strength

Using this test piece, the tensile strength after forming (MPa) was measured according to ISO 527-1:2012 (second edition) by performing a tensile test in a tensile tester (Autograph AG5000B, manufactured by Shimadzu Corporation), at room temperature, the initial-chuck distance of 100 mm, tensile speed of 5 mm/min. The results are shown in Table 1.

### Evaluation of Mechanical Strength after Heat-Moisture Treatment

The test piece was treated by immersing it in water at 120° C. for 500 hours (heat-moisture treatment). The tensile strength (MPa) described above was measured for the treated test piece.

Further, the strength retention rate was determined for the tensile strength after forming and the tensile strength after heat-moisture treatment using the following formula (1). As a result, the strength retention rate was 90%.

$$strength retention rate ( \% ) = \frac{tensile strength after heat - moisture treatment}{tensile strength after forming} \times 100 \qquad ( 1 )$$

### Comparative Example 1

A formed body was obtained in the same manner as in Example 1 except that no silane coupling agent was used. The mechanical strength and the mechanical strength after the heat-moisture treatment of the obtained formed body were measured in the same manner as in Example 1. The results are shown in Table 1. The strength retention rate was 70%.

TABLE 1

| | | | Ex. 1 | Comp. Ex. 1 |
|---|---|---|---|---|
| Composition | Silane coupling agent | | 1 | — |
| [parts by mass] | Carbon fibers 1 | | 28 | 28 |
| | SPS | | 95 | 95 |
| | modified PPE | | 5 | 5 |
| | Antioxidant 1 | | 0.2 | 0.2 |
| | Antioxidant 2 | | 0.2 | 0.2 |
| | Crystalline nucleating agent | | 0.3 | 0.3 |
| Evaluation | tensile strength | MPa | 126 | 114 |
| | after forming | | | |
| | tensile strength after | MPa | 113 | 80 |
| | heat-moisture treatment | | | |

### Example 2

To a total of 100 parts by mass of resin components (SPS: 95% by mass, fumaric acid-modified PPE: 5% by mass) contained in a thermoplastic resin composition, 31 parts by mass of carbon fibers 1, 1 part by mass of a silane coupling agent, 11 parts by mass of a rubber-like elastic body, 0.2 parts by mass of an antioxidant 1, 0.2 parts by mass of antioxidant 2, and 0.3 parts by mass of crystallization nucleating agent were kneaded by using a twin-screw kneader (ZSK32MC, manufactured by Coperion GmbH) having a cylinder diameter of 32 mm. The carbon fibers were side-feeded. The obtained pellet was injection-molded using an injection-molding machine (MD100, manufactured by NIIGATA MACHINE TECHNO CO., LTD.) at a cylinder temperature of 300° C. and a mold temperature of 150° C. to obtain a test piece. An ISO mold was used as the mold. The mechanical strength and the mechanical strength after the heat-moisture treatment of the obtained formed body were measured in the same manner as in Example 1. The results are shown in Table 2. The strength retention rate was 90%.

### Comparative Example 2

A formed body was obtained in the same manner as in Example 2 except that no silane coupling agent was used. The mechanical strength and the mechanical strength after the heat-moisture treatment of the obtained formed body were measured in the same manner as in Example 1. The results are shown in Table 2. The strength retention rate was 67%.

TABLE 2

| | | | Ex. 2 | Comp. Ex. 2 |
|---|---|---|---|---|
| Composition | Silane coupling agent | | 1 | — |
| [parts by mass] | Carbon fibers 1 | | 31 | 31 |
| | SPS | | 95 | 95 |
| | modified PPE | | 5 | 5 |
| | Rubber-like elastic body | | 11 | 11 |
| | Antioxidant 1 | | 0.2 | 0.2 |
| | Antioxidant 2 | | 0.2 | 0.2 |
| | Crystalline nucleating agent | | 0.3 | 0.3 |
| Evaluation | tensile strength | MPa | 145 | 135 |
| | after forming | | | |
| | tensile strength after | MPa | 131 | 90 |
| | heat-moisture treatment | | | |

### Example 3

A formed body was obtained in the same manner as in Example 1 except that carbon fibers 2 was used in place of carbon fibers 1. The mechanical strength and the mechanical strength after the heat-moisture treatment of the obtained formed body were measured in the same manner as in Example 1. The results are shown in Table 3.

### Comparative Example 3

A formed body was obtained in the same manner as in Example 3 except that no silane coupling agent was used. The mechanical strength and the mechanical strength after the heat-moisture treatment of the obtained formed body were measured in the same manner as in Example 1. The results are shown in Table 3.

TABLE 3

| | | | Ex. 3 | Comp. Ex. 3 |
|---|---|---|---|---|
| Composition | Silane coupling agent | | 1 | — |
| [parts by mass] | Carbon fibers 2 | | 28 | 28 |
| | SPS | | 95 | 95 |
| | modified PPE | | 5 | 5 |
| | Antioxidant 1 | | 0.2 | 0.2 |
| | Antioxidant 2 | | 0.2 | 0.2 |
| | Crystalline nucleating agent | | 0.3 | 0.3 |
| Evaluation | tensile strength | MPa | 127 | 114 |
| | after forming | | | |
| | tensile strength after | MPa | 88 | 86 |
| | heat-moisture treatment | | | |

### Example 4

A formed body was obtained in the same manner as in Example 2 except that carbon fibers 2 was used in place of carbon fibers 1. The mechanical strength and the mechanical strength after the heat-moisture treatment of the obtained formed body were measured in the same manner as in Example 1. The results are shown in Table 4.

### Comparative Example 4

A formed body was obtained in the same manner as in Example 4 except that no silane coupling agent was used. The mechanical strength and the mechanical strength after the heat-moisture treatment of the obtained formed body were measured in the same manner as in Example 1. The results are shown in Table 4.

TABLE 4

| | | | Ex. 4 | Comp. Ex. 4 |
|---|---|---|---|---|
| Composition | Silane coupling agent | | 1 | — |
| [parts by mass] | Carbon fibers 2 | | 31 | 31 |
| | SPS | | 95 | 95 |
| | modified PPE | | 5 | 5 |
| | Rubber-like elastic body | | 11 | 11 |
| | Antioxidant 1 | | 0.2 | 0.2 |
| | Antioxidant 2 | | 0.2 | 0.2 |
| | Crystalline nucleating agent | | 0.3 | 0.3 |
| Evaluation | tensile strength | MPa | 130 | 120 |
| | after forming | | | |
| | tensile strength after | MPa | 81 | 79 |
| | heat-moisture treatment | | | |

### Example 5

To a total of 100 parts by mass of resin components (PPS: 95% by mass, fumaric acid-modified PPE: 5% by mass) contained in a thermoplastic resin composition, 28 parts by mass of carbon fibers 1 and 1 part by mass of a silane coupling agent, were kneaded by using a twin-screw kneader (ZSK32MC, manufactured by Coperion GmbH) having a cylinder diameter of 32 mm. The carbon fibers were side-feeded. The obtained pellet was injection-molded using an injection-molding machine (MD100, manufactured by NIIGATA MACHINE TECHNO CO., LTD.) at a cylinder temperature of 320° C. and a mold temperature of 150° C. to obtain a test piece. An ISO mold was used as the mold. The mechanical strength and the mechanical strength after the heat-moisture treatment of the obtained formed body were measured in the same manner as in Example 1. The results are shown in Table 5. The strength retention rate was 80%.

### Comparative Example 5

A formed body was obtained in the same manner as in Example 5 except that no silane coupling agent was used. The mechanical strength and the mechanical strength after the heat-moisture treatment of the obtained formed body were measured in the same manner as in Example 1. The results are shown in Table 5. The strength retention rate was 70%.

TABLE 5

| | | | Ex. 5 | Comp. Ex. 5 |
|---|---|---|---|---|
| Composition | Silane coupling agent | | 1 | — |
| [parts by mass] | Carbon fibers 1 | | 28 | 28 |
| | PPS | | 95 | 95 |
| | modified PPE | | 5 | 5 |
| Evaluation | tensile strength | MPa | 180 | 165 |
| | after forming | | | |
| | tensile strength after | MPa | 144 | 116 |
| | heat-moisture treatment | | | |

From Examples 1 and 2, it can be seen that a formed body composed of a thermoplastic resin composition using a coupling agent is excellent in tensile strength after forming and tensile strength after heat-moisture treatment, and in particular, the strength retention rate after heat-moisture treatment is excellent at 80% or larger.

From Examples 3 and 4, it can be seen that the formed body composed of a thermoplastic resin composition using a coupling agent is excellent in tensile strength after forming and tensile strength after heat-moisture treatment even when carbon fibers are different from those of Examples 1 and 2 are used.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification and the specification of Japanese application(s) on the basis of which the present application claims Paris convention priority are incorporated herein by reference in its entirety.

1. A thermoplastic resin composition, comprising a thermoplastic resin (A) that is a polyphenylene sulfide resin, a polystyrene-based resin, or a polyamide resin, a polyarylene ether modified with a functional group (B), a coupling agent (C), and carbon fibers (D), wherein
the content of the thermoplastic resin (A) is 80 to 97 by mass in the resin component contained in the thermoplastic resin composition, and the content of the polyarylene ether modified with a functional group (B) is 3 to 20 by mass in the resin component contained in the thermoplastic resin composition.

2. The thermoplastic resin composition according to claim 1, wherein the thermoplastic resin (A) comprises syndiotactic polystyrene.

3. The thermoplastic resin composition according to claim 1 2, wherein the coupling agent (C) comprises one or more selected from the group consisting of a silane coupling agent, an aluminate coupling agent, and a titanate coupling agent.

4. The thermoplastic resin composition according to claim 1, wherein the coupling agent (C) comprises an isocyanate-based silane.

5. The thermoplastic resin composition according to claim 1, further comprising a sizing agent (E).

6. The thermoplastic resin composition according to claim 5, wherein the sizing agent (E) has an epoxy group.

7. The thermoplastic resin composition according to claim 1, wherein the polyarylene ether modified with a functional group (B) is a dicarboxylic acid-modified polyarylene ether.

8. The thermoplastic resin composition according to claim 7, wherein the dicarboxylic acid-modified polyarylene ether is a fumaric acid-modified polyarylene ether or a maleic anhydride-modified polyarylene ether.

9. A formed body composed of the thermoplastic resin composition according to claim 1.

10. The formed body according to claim 9, wherein the strength retention rate after the heat-moisture treatment at 120° C. for 500 hours represented by the following formula (1) is 80% or more.
$$strength retention rate ( \% ) = \frac{tensile strength after heat - moisture treatment}{tensile strength after forming} \times 100 \qquad ( 1 )$$

11. A formed body comprising a thermoplastic resin composition, the composition comprising a thermoplastic resin (A), a polyarylene ether modified with a functional group (B), and carbon fibers (D), wherein the strength retention rate after the heat-moisture treatment at 120° C. for 500 hours represented by the following formula (1) is 80% or more.
$$strength retention rate ( \% ) = \frac{tensile strength after heat - moisture treatment}{tensile strength after forming} \times 100 \qquad ( 1 )$$
